(19) United States
(12) Patent Application Publication
(10) Pub. No.: US 2014/0200990 A1
(43) Pub. Date: Jul. 17, 2014

(54) SCORING AND RANKING ADVERTISEMENT CONTENT CREATORS

(71) Applicant: Ana Caceres, L'Hospitalet de Llobregat (ES)

(72) Inventor: Ana Caceres, L'Hospitalet de Llobregat (ES)

(21) Appl. No.: 14/153,849

(22) Filed: Jan. 13, 2014

Related U.S. Application Data
(60) Provisional application No. 61/848,825, filed on Jan. 14, 2013.

(51) Int. Cl. G06Q 30/02

(52) U.S. Cl. CPC G06Q 30/0243
USPC 705/14.42

(57) ABSTRACT

Methods for scoring and ranking advertisement content creators.

### CROSS-REFERENCE TO RELATED APPLICATIONS

This application claims the benefit of U.S. Provisional Application No. 61/848,825, filed Jan. 14, 2013.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention relates in general to content creation, and in particular to scoring and ranking advertisement content creators.

The success of advertising campaigns is strongly related to advertisement effectiveness.

With continuous growth of internet usage, advertisers are shifting advertising budget to impact online audience, through Internet based advertising, also known as online advertising.

Online advertisements may be hosted in online advertising systems and may be presented to users as a result of an access to online content such as web pages, search engine results pages, online games, mobile content, email or by any other means.

Internet based advertising is well suited to testing different advertisements and gives advertisers the possibility to know which advertisements work better in terms of measurable results, such as visits to the advertiser's website, online purchases, brochure downloads, etc.

Users may get used to an online advertisement and ignore it after a certain period of time, that may be as short as a few days. So it is important to add new advertisements constantly in order to reduce or avoid advertisement staleness.

Testing many advertisements at the same time, comparing results and replacing the lowest performing ones with fresh ones, or just removing them, may also have a positive impact on advertisement effectiveness. In addition, some online advertising programs may increase the exposure of better performing advertisements at a lower cost for the advertiser.

Advertisement content creators working for advertisers in-house, in agencies or elsewhere, create advertisements with different performance results and may face limitations related to time, budget, language, language variations and/or any other factor, to create a higher volume of original advertisements and refresh them more frequently.

A wider range of advertisement content creators contributing or suggesting advertisements to advertisers may result in advertisers having more advertisements to test, broader possibilities of subtargeting, and may have a positive influence in overall advertisement effectiveness.

When presented with a high number of advertisements to test, advertisers may face a challenge deciding how to optimally select advertisements and/or combine advertisements from different advertisement content creators.

There is a need in the art for methods for scoring and ranking advertisement content creators.

### SUMMARY OF THE INVENTION

According to one aspect of the invention, a method may include identification of some or all the individuals and/or entities who create advertisements in a system.

The method may further include determining, storing and regularly updating scores associated to each one of these advertisement content creators, that may estimate the likelihood that a new advertisement from a certain advertisement content creator may have a certain level of effectiveness. The method may further include ranking advertisement content creators according to scores.

According to another aspect, a method may include providing advertisers with one or more suggested new advertisements created by advertisement content creators. Suggested new advertisements may go online automatically under certain conditions and be shown to users, or remain offline till advertisers check and decide whether to select some or all of them to be delivered to users.

According to another aspect, a method may include providing advertisement content creators with user interfaces to enter suggested new advertisements in the advertising management system and providing advertisers with user interfaces to view the new advertisements suggested by advertisement content creators and select all or some of them to be shown to users. The method may further include displaying to advertisers the scores associated to each advertisement content creator who suggested a new advertisement.

According to another aspect, a method may include calculation and process of compensation or reward to advertisement content creators according to scores and/or advertisements performance results and/or any other criteria.

According to another aspect, a method may include providing advertisers with a user interface with tools to search for, select and contact, individually or not, advertisement content creators meeting certain criteria, and to invite them to create suggested new advertisements for interested advertisers.

### DESCRIPTION OF DRAWINGS

FIG. 1 shows a schematic diagram of an exemplary online system including a network, an advertising management system, advertisers, publishers, advertisement content creators and users devices.

FIG. 2 shows an exemplary flow diagram in the online system.

FIGS. 3A, 3B, 3C, 3D, 3E and 3F show data tables including results of exemplary calculations of advertisement content creator scores.

FIG. 4 shows an exemplary flow diagram with suggested new advertisements and information about advertisement content creators' scores.

All figures are exemplary and do not limit the invention.

### DETAILED DESCRIPTION

Although the invention relates to content creation in general, description is focussed on Internet based advertising.

The following detailed description contains many specifics for the purposes of illustration, though anyone of ordinary skill in the art will appreciate that the invention may be embodied in other specific forms and many variations and alterations to the following details are within the scope of the invention. Accordingly, the following embodiments of the invention are set forth without any loss of generality to and without imposing limitations upon the invention.

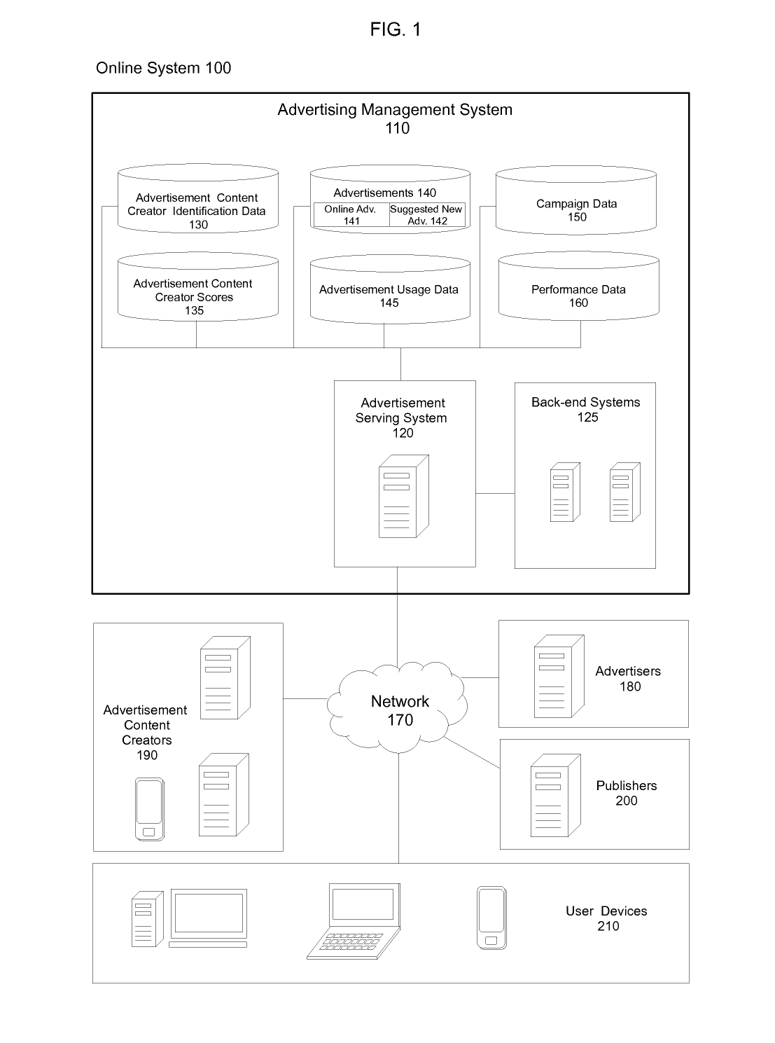

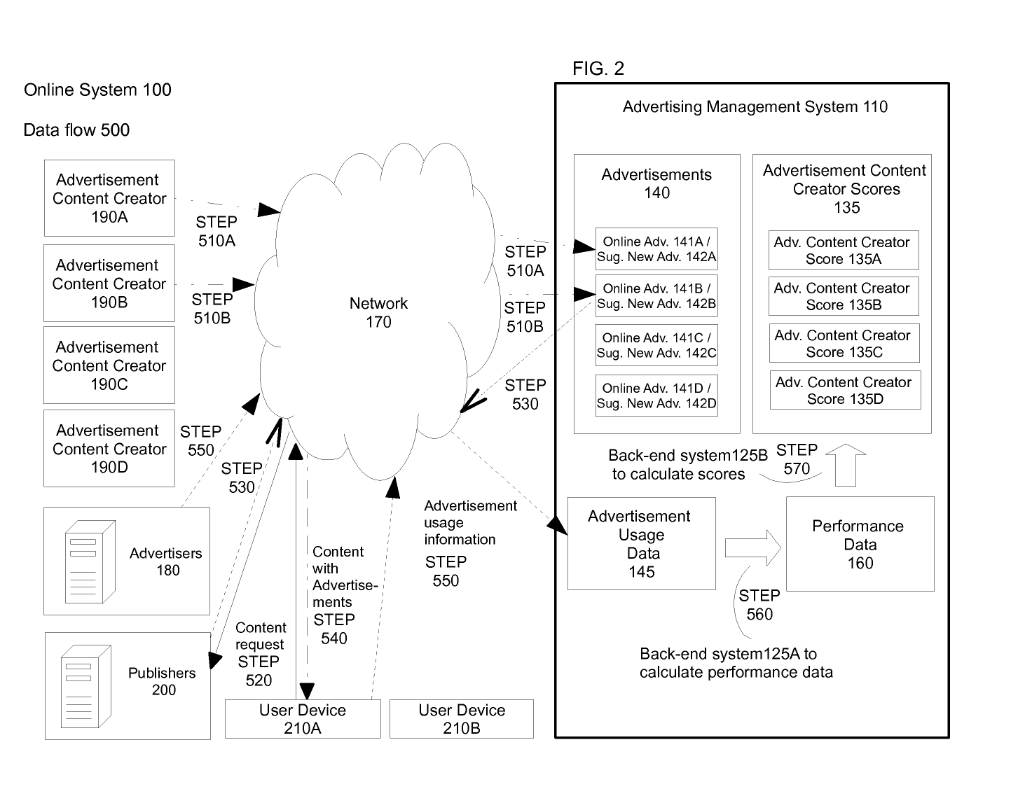

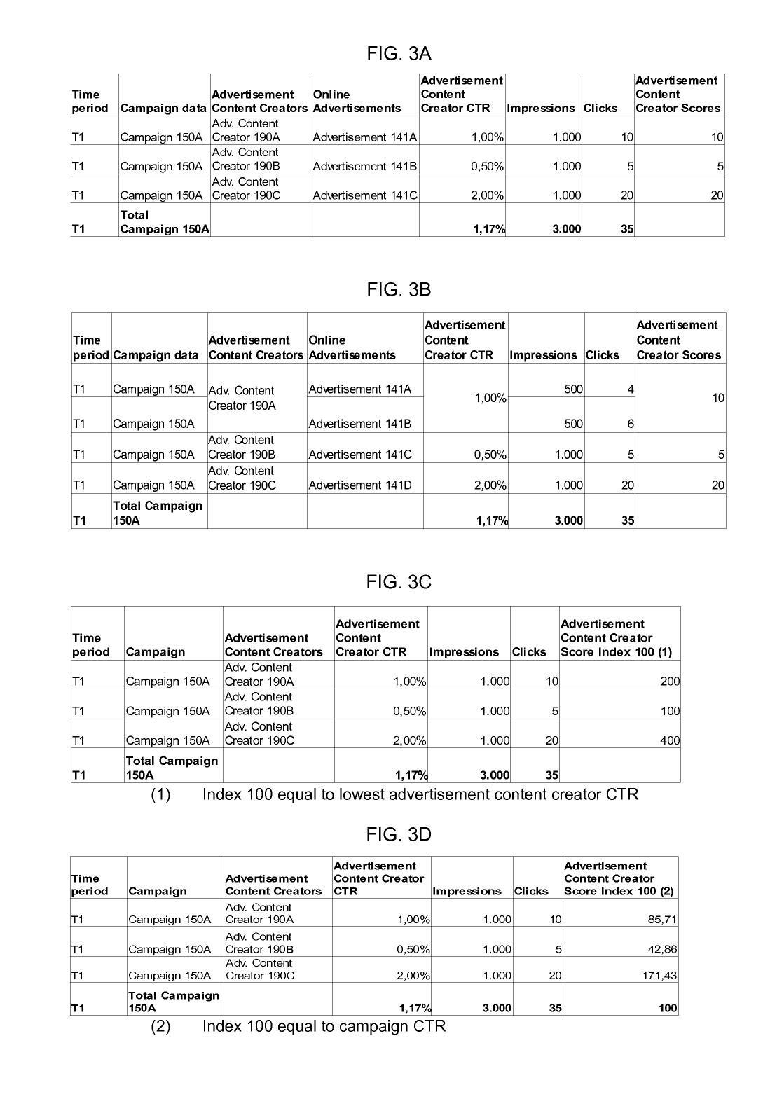

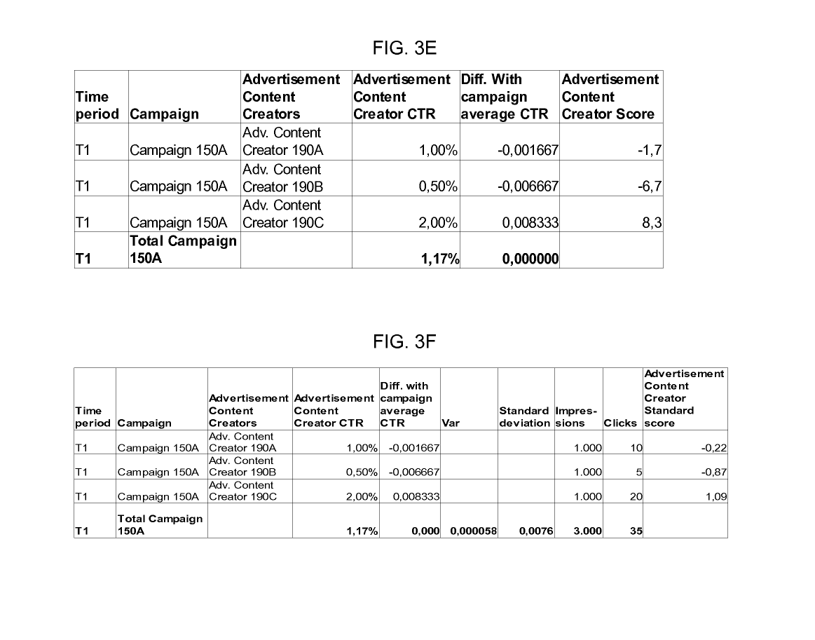

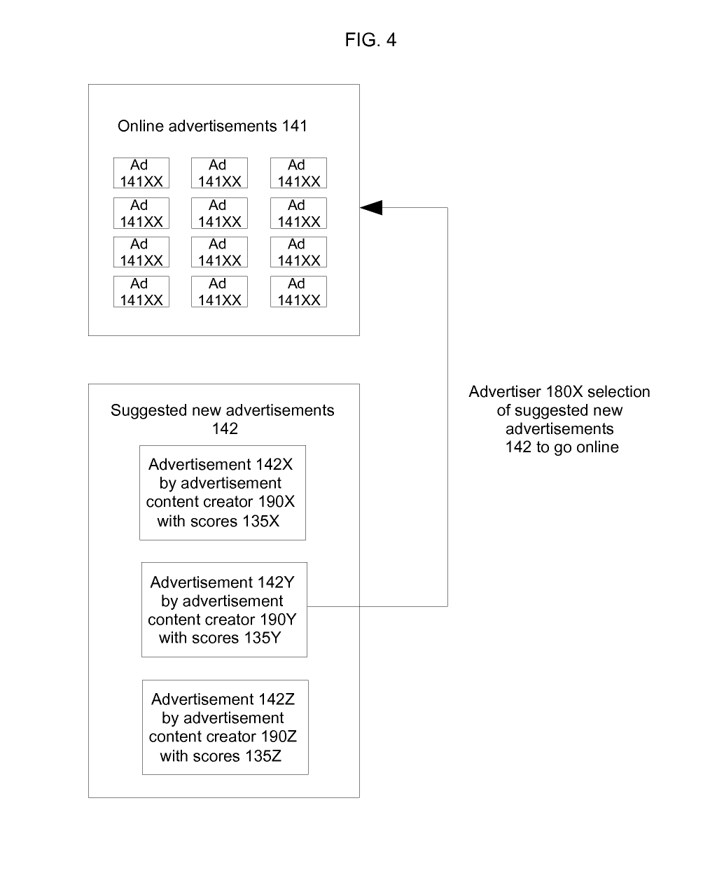

The following detailed description refers to the accompanying drawings. For purposes of explanation only, certain aspects of this disclosure are described with reference to the discrete elements and exemplary calculations illustrated in FIG. 1, FIG. 2, FIG. 3A to 3F and FIG. 4. The number, identity and arrangement of elements in the accompanying drawings are not limited to what is shown and the same reference numbers in different drawings may identify the same or similar elements.

Furthermore, additional and/or different elements not shown may be contained in or coupled to the elements shown in the accompanying drawings and/or certain illustrated elements may be absent.

FIG. 1 shows an exemplary representation of an online system 100.

While reference is made to creating and distributing advertisements, the online system 100 may be suitable for creating and distributing other forms of content, including sponsored and/or promoted content.

The online system 100 contains a network 170, that may comprehend one or more telecommunications networks, such as computer networks, telephone or other communications networks, the Internet and/or any other elements that facilitate communications among and between network nodes. The network 170 may include shared, public, and/or private data networks including wide area or local area, and may facilitate wired and/or wireless connectivity and communication amongst one or more advertising management systems 110, one or more advertisers 180, one or more advertisement content creators 190, one or more publishers 200, one or more user devices 210 and other elements (not shown in FIG. 1).

The online system 100 may include thousands of advertising management systems 110, advertisers 180, advertisement content creators 190, publishers 200, user devices 210 and other elements, though the representation in FIG. 1 shows only a limited number of elements for illustration purposes.

Each of the elements may be implemented or associated with hardware components, software components, firmware components or any combination of such components.

In some implementations, the advertisement serving system 120 can be coupled to one or more store units, such as an advertisement content creator identification data 130 store unit, an advertisement content creator scores 135 store unit, an advertisements 140 store unit, an advertisement usage data 145 store unit, a campaign data 150 store unit, a performance data 160 store unit and/or any other.

An advertisement 140 may be any type of communication, with commercial or non commercial purposes, related to the promotion of one or more products, services, ideas, brands, organizations and/or others. In some implementations, advertisements 140 may be communicated online, as any type of electronic advertisement document, including elements like text, image, audio, video and/or a combination of one or more of any of such elements and/or any other advertising media. Advertisements 140 may also include embedded information, such as links that direct users to a certain website or content item when the user selects or interacts with the advertisement 140.

Advertisements 140 comprehend online advertisements 141, that are already being served to users, and suggested new advertisements 142, created by advertisement content creators.

In some embodiments, suggested new advertisements 142 may go online automatically as online advertisements 141 under certain conditions set by advertisers, including conditions related to advertisement content creators scores. In other embodiments, advertisers 180 may have to periodically check the suggested new advertisements 142 and select which ones are to be shown to users as online advertisements 141.

Presentation of an online advertisement 141 to a user is referred to hereinafter as an “impression”, meaning any form of display of an online advertisement 141 such that it is viewable/receivable to a user through an user access device 210.

User selection or interaction with an online advertisement 141 is referred to hereinafter as a “click” and may result in the user being directed to a certain website or content item.

A “conversion” happens when a user undertakes a measurable action, such as a purchase, a brochure download, a newsletter subscription or any other desired action, related to a previously served online advertisement 141.

Advertising management systems 110 usually record information about advertisement usage data 145, including information provided by advertisers 180 and/or user devices 210. Advertisement usage data 145 comprehend measured or observed user behaviour related to each one of the online advertisements 141 served, for example, clicks and conversions, recorded for billing and other purposes, such as attempting to determine advertisement quality in terms of effectiveness. There are many other types of advertisement usage data 145 other than clicks and conversions.

Performance data 160, including but not limited to click through rate (CTR) and conversion rate based on advertisement usage data 145, may also offer information about advertisement effectiveness.

The click through rate (CTR) represents the number of clicks on a given online advertisement 141 divided by the number of impressions and expressed as a percentage.

The conversion rate is the ratio of visitors to a certain website or content item who convert online advertisement views or online advertisement selections into measurable desired actions.

There are many more performance indicators that may be included in performance data 160.

An online advertising campaign defined in campaign data 150 and set up directly or indirectly by an advertiser 180, may contain budget restrictions as well as targeting criteria (for example, user geolocation, languages, time of the day, frequency and/or criteria related to user profile and/or online behaviour) that may limit the conditions under which an online advertisement 141 is served for presentation to a user device 210.

Publishers 200 may include any individuals or entities associated to network distributed content, such as online newspapers, blogs, social networks, online service providers, websites, search engines and others, that may show online advertisements 141.

Advertisers 180 may include or be associated with people, organisations, companies and/or any other entities that provide products and/or services related or are otherwise associated with advertisements 140.

Advertisement content creators 190 may include individuals and/or entities involved in content creation for advertising purposes.

User devices 210 may include any devices capable of receiving information from the network 170, such as personal computers, mobile computing devices, cell phones, smart phones, other electronic devices and the like.

The advertising management system 110 may manage online advertisements 141 and may distribute or target them to user devices 210 directly or through publishers 200. As mentioned before, the advertising management system 110 may also record or log advertisement usage data 145 related to user behaviour associated with user's view, interaction or selection of one or more online advertisements 141, including tracking before, during and after view or selection.

In some embodiments, the advertising management system 110 may include one or more advertisement serving systems 120 and one or more back-end systems 125 and/or any other running processes that may perform functionalities associated with delivering online advertisements 141 to publishers 200 or user access devices 210, processing advertisement usage data 145 in order to calculate, store and update performance data 160 and processing performance data 160, advertisement usage data 145 and any other information to calculate, store and update advertisement content creator scores 135.

In another embodiment, the advertising management system 110 may provide reporting to advertisers 180 and/or publishers 200, including information about advertisement usage data 145, performance data 160 and/or advertisement content creator scores 135.

The advertising management system 110 may provide publishers 200, advertisers 180, advertisement content creators 190 and others with user interfaces to interact with the advertising management system 110.

Advertisement content creators 190 may enter suggested new advertisements 142 in the advertising management system 110 through the interfaces provided. Advertisement content creators 190 may also enter, modify and update information in the advertisement content creator identification data 130 through the interfaces provided.

In another embodiment, advertisement content creator identification data 130 may also include information collected by the advertising management system 110 in relation to each advertisement content creator 190, for example, geolocation, time since first suggested new advertisement 142 and volume of suggested new advertisements 142 created.

In some embodiments, advertisement content creators 190 may also be able to check their advertisement content creator scores 135 in the advertising management system 110 through the interfaces provided.

In some implementations, advertisement content creators 190 may be required to create user name and password to access the interfaces.

Advertisers 180 may, directly or indirectly, enter, modify, set online, set offline and track advertisements 140 and other advertisement information, as well as specify campaign data 150 in the advertising management system 110 through interfaces provided.

In some embodiments advertisers 180 may be able to check suggested new advertisements 142 created by advertisement content creators 190, and to select some or all of them to be shown to users as online advertisements 141, basing their selection on advertisement content creator scores 135 and/or any other criteria.

In other embodiments, suggested new advertisements 142 may go online automatically as online advertisements 141 under certain conditions defined by the advertiser 180.

Either if advertisers 180 check and select suggested new advertisements 142 to be shown online to users as online advertisements 141 or set conditions for suggested new advertisements 142 to go online automatically, advertisers 180 may have a larger number of online advertisements 141 at their disposal. Advertisers 180 may use these online advertisements 141 for testing, comparing results and optimizing the campaign with the best performing ones, increasing subtargeting and reducing advertisement staleness.

In some implementations, advertisers 180 may be enabled to search for and contact advertisement content creators 190 meeting certain criteria (geolocation, advertisement content creator scores, language, language register and/or geographical variations, dialect, accent, market niche specialisation, etc.) in order to invite them to create suggested new advertisements 142 for the interested advertisers 180.

Advertisers 180 may be enabled to perform searches by filtering information in the advertisement content creator identification data 130 and advertisement content creator scores 135 through interfaces provided and/or by posting invitations to be seen by advertisement content creators 190 through interfaces provided, and/or by any other means.

In addition, the advertising management system 110 may calculate and process financial transactions among and between elements in the online system 100, like advertisement usage-related and/or advertisement performance-related debits in accounts associated with advertisers 180, advertisement usage-related and/or advertisement performance-related remuneration to publishers 200 as well as advertisement content creators scores-related and/or advertisement usage-related and/or advertisement performance-related remuneration to advertisement content creators 190. Remuneration may be in the form of credits in accounts associated with publishers 200 and/or advertisement content creators 190, cash, stock options, coupons or by any other means.

FIG. 2 illustrates an exemplary data flow 500 within the online system 100. The representation in FIG. 2 shows only a limited number of elements for illustration purposes. The data flow 500 is not intended to be restrictive. Other data flows may therefore occur in the online system 100 and, even with the data flow 500, the illustrated events and their particular order in time may vary.

As explained before, advertisement content creators 190 may access the advertising management system 110 through interfaces provided and enter suggested new advertisements 142 for a specific advertiser 180, product, campaign, etc. As an example, in FIG. 2 advertisement content creator 190A generates suggested new advertisement 142A in the advertising management system 110 (STEP 510A), advertisement content creator 190B generates suggested new advertisement 142B (STEP 510B), advertisement content creator 190C generates suggested new advertisement 142C and advertisement content creator 190D generates suggested new advertisement 142D.

For this example we consider only one advertiser 180A.

Advertiser 180A checks and sets online the four suggested new advertisements through interfaces (not shown in FIG. 2), which start showing to users as online advertisement 141A, 141B, 141C and 141D.

A user, through a user device 210A, submits a content request (STEP 520).

Publishers 200 may receive the content request from the user device 210A (or other elements in the environment 100), through the network 170 (STEP 520), and provide content to the requesting device via various media and in various forms, including web based and non-web based media and forms (STEP 530).

The content received by the user (STEP 540) may include online advertisements 141 provided by the advertising management system 110 (STEP 530) or executable instructions to be executed at the user device 210 in order to request online advertisements 141 from the advertising management system 110.

In some implementations, online advertisements 141 may be provided to publishers 200 by the advertising management system 110 to be integrated in content before delivering content to user devices 210 (STEP 540) as a result of a content request (STEP 520).

Users may interact with online advertisements 141.

Advertisement impressions and associated advertisement usage data 145, including information provided by advertisers 180 and/or user devices 210 to the advertising management system 110 (STEP 550), may be stored in advertisement usage data 145 unit, or another unit (not shown in FIG. 2).

As mentioned before, back-end systems 125 and/or any other running processes (not shown in FIG. 2) may also process advertisement usage data 145 in order to calculate, store and update performance data 160 (STEP 560), including CTR and/or conversion rate, and process performance data 160, usage data 145 and/or any other information to calculate, store and update advertisement content creator scores 135 (STEP 570).

FIGS. 3A, 3B, 3C, 3D, 3E and 3F show some exemplary tables with data and calculation results of advertisement content creator scores 135, not intended to be restrictive.

For the purpose of example, only impressions, clicks and CTR are considered in the calculations in FIG. 3A to 3F, though there are many other advertisement usage data 145, performance data 160 and other information that may be used to calculate advertisement content creators scores 135.

In order to illustrate an exemplary calculation of advertisement content creator scores 135, in FIG. 3A we consider a single campaign defined in campaign data 150A, with 3 online advertisements 141 promoting the same advertising property. Advertisement 141A has been created by advertisement content creator 190A, advertisement 141B by advertisement content creator 190B and advertisement 141C by advertisement content creator 190C.

In this example we consider the three online advertisements 141 are shown to users under the same advertisement trigger for a certain period of time T1 in the same ad placement.

In FIG. 3A we calculate one single performance indicator as an example, like CTR, and we consider these three online advertisements 141 have the same number of impressions and different volume of clicks for each one, in the period of time considered, ceteris paribus:

CTR of online advertisement 141A by advertisement content creator 190A=1%

CTR of online advertisement 141B by advertisement content creator 190B=0.5%

CTR of online advertisement 141C by advertisement content creator 190C=2%

Online advertisement 141C, by advertisement content creator 190C, shows a better performance in terms of CTR, as it has generated more clicks than the rest. So we can simply rank advertisement content creators 190 from best to worst results according to the selected performance indicator, for example, A, B, C or 1, 2, 3.

Advertisement content creator 190C: 1

Advertisement content creator 190A: 2

Advertisement content creator 190B: 3

Additionally, we can assign scores related to performance indicator value, for example, by multiplying advertisement content creator CTR by 1000:

Advertisement content creator 190C: 20 scores

Advertisement content creator 190A: 10 scores

Advertisement content creator 190B: 5 scores

and rank them according to scores.

FIG. 3B shows another embodiment, where advertisement content creators 190 may contribute with several online advertisements 141 to the same campaign. Advertisement content creator scores 135 may be calculated by adding all the data related to online advertisements 141 created by the same advertisement content creator 190, calculating a performance indicator, for instance, CTR, for each advertisement content creator 190, and assigning scores according to results, for example, by multiplying advertisement content creator CTR by 1000.

FIG. 3C shows another embodiment of the present invention, where scores may be calculated according to an index 100 (or any other type of index) that may be set for the lowest performance indicator value and the rest calculated from there.

In another embodiment, an index 100 or another index may be set for campaign average CTR (FIG. 3D).

In FIG. 3E, as another embodiment, scores may be calculated according to the difference between the performance indicator value for each advertisement content creator 190 (advertisement content creator CTR, in this example) and the campaign performance indicator (campaign CTR) mean and multiplying the difference by 1000.

In another embodiment, advertisement content creator scores 135 may be calculated according to the difference between the performance indicator value for a certain advertisement content creator 190X and a partial campaign performance indicator mean (excluding data related to online advertisements 141 created by that specific advertisement content creator 190X whose scores are calculated).

In other embodiments, a standard score, also known as z-score, may be calculated for each advertisement content creator performance indicator value in relation to campaign average data or any other average data. The standard score is obtained by subtracting the chosen campaign performance indicator mean from an advertisement content creator performance indicator value and dividing the difference by the campaign performance indicator standard deviation (FIG. 3F).

In another embodiment, statistical analysis, like z-tests, t-tests, analysis of variance (ANOVA) and others, may be used to detect differences in means in the outcome variable related to the analized advertisement content creators. Many outcome variables and predictor variables may be used in the statistical analysis.

In the following example, a one-way between groups ANOVA is used, being the outcome variable Y the click-through rate (CTR) for the online advertisements in one single campaign, with a minimum number of impressions and clicks in a time span and the same advertisement placement. And being the predictor X.sub.1 a categorical variable representing the different groups of advertisements created by each one of the advertisement content creators contributing advertisements to the campaign:

Y=B.sub.0+B.sub.1*X.sub.1+error

The F-test or F-ratio statistic detects variance between groups of advertisements relative to variance within groups and the existence of an overall significant effect.

Post hoc tests, including but not limited to Tukey's test, allow for multiple pairwise comparisons.

Scores may ba calculated upon differences in means for each advertisement content creator or by difference related to global campaign mean.

If the assumptions for conducting a t-test or ANOVA are violated, there are many options, including but not limited to variable transformation or non parametric tests.

In other embodiments of the present invention, many other performance indicators in performance data 160 and/or a combination of them and/or advertisement usage data 145 and/or any other information may be used to calculate advertisement content creator scores 135 and/or rank advertisement content creators 190.

Many different types of advertisement content creator scores 135 may be calculated for each advertisement content creator 190, depending on the variables considered for each score and calculations made. In addition, a final global score for each advertisement content creator 190 may be computed based on one or more of the above mentioned data, as well as any suitable additional variables.

In other embodiments, some or all variables included in the calculation may be weighted according to relative importance and/or to compensate results from advertisements created by different advertisement content creators 190 with different weight in the campaign (due to different volume of impressions per advertisement content creator 190 and/or any other reason) and/or any other circumstances (including but not limited to advertisements being shown to users in different context, different advertisement trigger and/or landing page, industry competitiveness and historical data).

In another embodiment, a constant may be added to advertisement content creator scores 135 calculation, based on time in the program for that advertisement content creator, volume of advertisements created, and/or any other condition.

In other embodiments, values may be normalized.

All these embodiments admit a mix of online advertisements 141 with and without identified advertisement content creators 190.

So, as explained before, computation of advertisement content creators scores 135 may range from very simple calculations, related to online advertisements 141 from different advertisement content creators 190 in the same campaign, with the same advertisement trigger, for the same period of time, ceteris paribus, to very complex calculations comparing information related to online advertisements 141 from different advertisement content creators 190 in different contexts and time periods.

The former examples are not restrictive and many other options regarding calculation of advertisement content creators scores 135 are within the scope of the invention.

Advertisement content creators scores 135 and ranks may be expressed as numbers, categories, percentiles or any other suitable expression.

As mentioned before, advertisement content creators scores 135 may reflect the likelihood that a new advertisement 140 created by a specific advertisement content creator 190 may have a certain level of effectiveness.

FIG. 4 illustrates an exemplary process where an advertiser 180 examines and selects some suggested new advertisements 142, created by advertisement content creators 190, to go online and be shown to users as online advertisements 141. The advertiser 180 is provided with information about advertisement content creators scores 135.

In another example, advertiser 180 may select all the suggested new advertisements 142 to be shown to users.

In another embodiment, advertisers 180 may have the possibility to set all suggested new advertisements 142 to go online automatically without previous check.

In another embodiment, advertisers 180 may have the possibility to set online automatically only those suggested new advertisements 142 meeting certain criteria, related or not with advertisement content creator scores 135.

It will be apparent to one of ordinary skill in the art that aspects of the invention, as described above, may be implemented in many different forms of software, firmware, and hardware. Thus, the operation and behaviour of the aspects have been described without reference to the specific software code, it being understood that one of ordinary skill in the art would be able to design software and control hardware to implement the aspects based on the description herein.

1. A computer-implemented method comprising: accepting, with an advertising system including at least one computer, information identifying one or many individuals or entities who create advertisement content in the advertising system; calculating scores for each one of these individuals or entities from logged advertisement performance information recorded and stored in the system; storing calculated advertisement content creators scores; ranking advertisement content creators according to scores.

2. The method in claim 1 including recalculating and updating advertisement content creators scores.

3. The method in claim 1 including calculating and processing compensation or reward to advertisement content creators according to scores and/or advertisement performance and/or usage data and/or any other criteria.

4. The method in claim 1 including computer-implemented tools enabling advertisers to select advertisement content creators meeting certain criteria, including but not limited to advertisement content creators scores. Advertisers may be enabled to contact selected advertisement content creators.

5. On a computer, producing a user interface operable by a user, which enables a plurality of advertisement content creators entering suggested advertisements.

6. On a computer, producing a user interface operable by a user, which allows advertisers to review, select and use advertisements suggested by a plurality of advertisement content creators, and enabling advertisers to view advertisement content creators scores.
